(19) United States
(12) Patent Application Publication
(10) Pub. No.: US 2025/0362431 A1
(43) Pub. Date: Nov. 27, 2025

(54) DUAL-RESPONSIVE DISPLAYS AND DUAL-RESPONSIVE PHOTOENCRYPTION DISPLAYS FOR REWRITABLE PHOTOLUMINESCENCE AND STRUCTURAL COLOR DISPLAYS

(71) Applicant: UIF (University Industry Foundation), YONSEI UNIVERSITY, Seoul (KR)

(72) Inventors: Cheolmin PARK, Seoul (KR); Jin Woo OH, Seoul (KR); Hyowon HAN, Seoul (KR); Hyeokjung LEE, Seoul (KR)

(73) Assignee: UIF (University Industry Foundation), YONSEI UNIVERSITY, Seoul (KR)

(21) Appl. No.: 19/216,829

(22) Filed: May 23, 2025

(30) Foreign Application Priority Data
May 23, 2024 (KR) 10-2024-0067185
May 22, 2025 (KR) 10-2025-0066616

(51) Int. Cl. G02B 1/00; G02B 1/04; G09G 3/20

(52) U.S. Cl. CPC G02B 1/005; G02B 1/04; G09G 3/2003; G09G 2358/00

(57) ABSTRACT

The present disclosure relates to a dual-responsive display and a dual-responsive photoencryption display for rewritable photoluminescence and structural color display, and according to an embodiment, a dual-mode encryption display is provided which independently and simultaneously controls the wavelength of structural color and the intensity of luminescence, thereby guaranteeing high information security and anti-counterfeiting.

### CROSS-REFERENCE TO RELATED APPLICATION

This application claims the benefit of Korean Patent Application No. 10-2024-0067185 filed on May 23, 2024, and Korean Patent Application No. 10-2025-0066616 filed on May 22, 2025, in the Korean Intellectual Property Office, the entire disclosure of which is incorporated herein by reference for all purposes.

### BACKGROUND OF THE INVENTION

The present disclosure relates to information security, particularly to optical encryption, and more specifically to a dual-responsive photoencryption display for rewritable photoluminescence and structural color display.

Information security has attracted much attention because of its significance in diverse areas, ranging from banknotes and military fields to daily use. Particularly, in the information age, the demand for information storage and security technologies has increased to prevent the leakage and counterfeiting of personal information and privacy, which are some of the most concerning issues today. Optical information technology, also known as optical encryption, is promising owing to its wide availability because it is intuitive and identifiable by the human eye without sophisticated devices. Optical encryption has been developed using various programmable coloration and photoluminescent materials.

Coloration is the optical phenomenon of the selective reflection and absorption of certain wavelengths of light. When light strikes an object, certain wavelengths are absorbed by the surface, and others are reflected. The specific combination of absorbed and reflected wavelengths gives a material its characteristic color. Information written with colored ink can be visualized using a stimulus-dependent color arising from the wavelength-selective absorption or reflection (transmission) of the stimulus. A variety of colored materials, including spiropyran, spirooxazine, diarylethene, oxazine, and oxazolidine derivatives, has been employed for optical encryption in response to external stimuli such as light irradiation, vapor, heat, exposure to acid or base solution, mechanical force, electric field, or their combination. However, conventional colored compounds only show a single or few colorations as an on-off switch with a slow response rate, which limits their implementation in optical encryption.

Alternatively, photoluminescent (PL) materials are frequently used for optical encryption owing to their self-emitting fluorescence and/or phosphorescence with a fast response under UV irradiation. The stimuli-dependent intensity, wavelength, and lifetime (decay time) of PL have been extensively employed in optical encryption with diverse organic and inorganic PL materials, including organic dyes, polymer dots, carbon dots, quantum dots, and lanthanide-doped nanoparticles. Recently, diverse attempts at high-security optical encryption have been made by combining PL materials with further light-controlling functions, such as a shape-memory matrix, resonance emission by geometric patterns, and electroluminescence. However, these approaches require additional optical and electronic instruments to decrypt encrypted information.

High-security optical encryption can be achieved by combining coloration and PL manipulation under daylight and UV light, respectively, which effectively camouflages information and prevents it from being counterfeited. Despite material design efforts to integrate coloration with PL for dual-responsive encryption for high-security optical encryption, only a few studies have exhibited separate (independent) manipulation of coloration and PL. Most coloration inevitably affects the PL properties and vice versa because the change in the molecular structure of colored materials associated with stimulus-responsive coloration often alters the energy level of the materials. We envision that the development of a novel material system with the complementary integration of independently controllable stimulus-responsive coloration and PL would give rise to high-security-level optical encryption. Considering that the structural color (SC) arising from the selective reflection of light from a photonic crystal (PC) allows broader stimulus-responsive coloration over the full visible range than isomerization-based organic-colored compounds, the development of an integrated SC and PL system is rational. Moreover, when the SC and PL are rewritable, such dual-programmable encryption can further broaden its functionality.

### Prior-Art Document

### Patent Document

Korean Patent No. 10-2159085 (B1) (published on Sep. 23, 2020)

### SUMMARY OF THE INVENTION

### Problem to be Solved by the Invention

An object of the present disclosure is to provide a dual-responsive display including rewritable photoluminescence and structural color, a dual-responsive photoencryption display, a method of manufacturing the same, and an encryption method using the same.

### Means for Solving the Problem

In order to achieve the above object, the present disclosure provides a dual-responsive display including: a block copolymer (BCP) photonic crystal (PC) film having a lamellar structure in which a first layer in which a first repeating unit is positioned and a second layer in which a second repeating unit coupled with the first repeating unit is positioned are alternately stacked, and exhibiting a structural color; and nanocrystals exhibiting fluorescent photoluminescence dispersed in one of the first layer and the second layer, wherein the structural color and the fluorescent photoluminescence are independently controlled.

In addition, the present disclosure provides a dual-responsive photoencryption display including: a block copolymer (BCP) photonic crystal (PC) film having a lamellar structure in which a first layer in which a first repeating unit is positioned and a second layer in which a second repeating unit coupled with the first repeating unit is positioned are alternately stacked; a first precursor compound bonded to one of the first and second repeating units in a plurality of different regions of the block copolymer (BCP) photonic crystal (PC) film; and nanocrystals exhibiting fluorescent photoluminescence, which are dispersed in a part of the plurality of different regions and positioned in one of the first layer and the second layer.

In addition, the present disclosure provides a method of manufacturing a dual-responsive display including: a first step of forming a block copolymer (BCP) photonic crystal (PC) film on a substrate; a second step of doping a first precursor compound into the formed block copolymer photonic crystal film; and a third step of forming nanocrystals within the block copolymer photonic crystal film by introducing a second precursor compound which reacts with the first precursor compound into a region doped with the first precursor compound, wherein the block copolymer (BCP) photonic crystal (PC) film has a lamellar structure in which a first layer in which a first repeating unit is disposed and a second layer in which a second repeating unit coupled with the first repeating unit is disposed are alternately stacked.

In addition, the present disclosure provides a method of manufacturing a dual-responsive photoencryption display including: a first step of forming a block copolymer (BCP) photonic crystal (PC) film on a substrate; a second step of doping a first precursor compound into at least a partial region of the formed block copolymer photonic crystal film; and a third step of introducing a second precursor compound, which reacts with the first precursor compound, into at least a part of the region doped with the first precursor compound to form nanocrystals within the block copolymer photonic crystal film, wherein the block copolymer (BCP) photonic crystal (PC) film has a lamellar structure in which a first layer in which a first repeating unit is disposed and a second layer in which a second repeating unit coupled to the first repeating unit is disposed are alternately stacked.

In addition, the present disclosure provides an encryption method including: a first step of introducing a second precursor compound, which reacts with a first precursor compound, into at least a part of a region doped with the first precursor compound in a block copolymer photonic crystal film doped with the first precursor compound in at least a partial region, thereby inputting a code into the block copolymer photonic crystal film; and a second step of sequentially irradiating visible light and ultraviolet light onto the block copolymer photonic crystal film into which the code has been input, to read the code.

According to an embodiment of the present disclosure, it is possible to guarantee high information security and anticounterfeiting by providing a dual-mode encryption display which independently and simultaneously controls the wavelength of structural color and the intensity of photoluminescence.

### BRIEF DESCRIPTION OF THE DRAWINGS

FIG. 1 shows a schematic diagram of a two-step manufacturing process of a block copolymer photonic crystal film in which perovskite nanocrystals are embedded and photographs of BCP PC films manufactured thereby according to an embodiment of the present disclosure.

FIG. 2 shows molecular structures and microstructures of BCP PC with perovskite nanocrystals according to an embodiment of the present disclosure and comparative examples, which were examined using various techniques.

FIG. 3 shows results of preferential doping of PbBr₂ into quaternized P2VP domains of a BCP PC film to control the structural color of the BCP PC according to an embodiment of the present disclosure.

FIG. 4 shows results of examining photophysical properties of CsPbBr₃ nanocrystals synthesized in quaternized P2VP lamellae through a first step (STEP I) and a second step (STEP II) using steady-state and time-resolved PL spectroscopy according to an embodiment of the present disclosure.

FIG. 5 shows that an SC and PL dual-mode BCP PC film may encode or decode much complicated information for highly sophisticated anti-counterfeiting system through micro-patterning according to an embodiment of the present disclosure.

FIG. 6 illustrates writing of SC and PL, removal using an ammonia solution, and repetitive writing/removal according to an embodiment of the present disclosure.

FIG. 7 shows that a rewritable dual-mode BCP PC display according to an embodiment of the present disclosure was successfully employed in a proof-of-concept encryption platform for a Morse code-based high-security-level rewritable optical encryption.

### DETAILED DESCRIPTION

Hereinafter, embodiments of the present disclosure will be described in detail with reference to the accompanying drawings. The present disclosure may have various modifications and forms, and specific embodiments thereof are illustrated in the drawings and described in detail herein. However, this is not intended to limit the present disclosure to specific disclosure, but should be understood to include all modifications, equivalents, or substitutes included in the spirit and technical scope of the present disclosure. In describing each drawing, similar reference numerals are used to refer to similar components. In the accompanying drawings, the dimensions of structures are shown enlarged from the actual size to ensure clarity of the present disclosure.

The terms such as first and second may be used to describe various components, but such components should not be limited by such terms. The above terms are used merely to distinguish one component from another. For example, without departing from the scope of the present disclosure, a first component may be named a second component, and similarly, a second component may also be named a first component.

The terminology used in the present application is used only to describe particular embodiments and is not intended to limit the present disclosure. Singular expressions include plural expressions unless the context clearly indicates otherwise. In the present application, it should be understood that terms such as “include,” “comprise” or “have” are intended to specify the presence of a feature, number, step, operation, component, part, or combination thereof described in the specification, but do not exclude in advance the possibility of the presence or addition of one or more other features, numbers, steps, operations, components, parts, or combinations thereof.

Unless otherwise defined, all terms used herein, including technical or scientific terms, have the same meaning as commonly understood by a person skilled in the art to which the present disclosure pertains. Terms defined in commonly used dictionaries should be construed as having meanings consistent with their meanings in the context of the relevant art, and will not be construed in an idealized or overly formal sense, unless expressly defined in the present application.

A dual-responsive display according to the present disclosure includes a block copolymer (BCP) photonic crystal (PC) film having a lamellar structure in which a first layer in which a first repeating unit is positioned and a second layer in which a second repeating unit coupled with the first repeating unit is positioned are alternately stacked, and exhibiting structural color, and nanocrystals exhibiting fluorescent photoluminescence dispersed in one of the first layer and the second layer, wherein the structural color and the fluorescent photoluminescence may be independently controlled.

The block copolymer photonic crystal film may include a poly(styrene-block-2-vinylpyridine) (PS-b-P2VP) copolymer, and the first and second repeating units may each include a PS repeating unit and a P2VP repeating unit. For example, the number-average molecular weight of the poly(styrene-block-2-vinylpyridine) (PS-b-P2VP) copolymer may be 80 to 100 kg/mol.

The poly(2-vinylpyridine) (P2VP) repeating units may be cross-linked to each other. Specifically, the P2VP repeating units may be cross-linked via an organic compound. More specifically, the P2VP repeating unit may have a quaternized pyridine group. The organic compound may include at least one selected from the group consisting of dibromobutane, 1-bromoethane, dichlorobutane, chloroethane, diiodobutane, and iodoethane.

A first precursor compound of the nanocrystal may further be included, which is coordinately bonded to the P2VP repeating unit. Specifically, the first precursor compound may be coordinately bonded to a quaternized P2VP repeating unit chain. By including the first precursor compound, structural color may be exhibited. For example, PL intensity may increase according to the concentration of the first precursor compound.

Specifically, the nanocrystals may be formed by a reaction between the first precursor compound and the second precursor compound, and dispersed in a layer among the first and second layers in which the P2VP repeating unit is positioned.

When the nanocrystals are included as described above, the structural color may be exhibited when irradiated with visible light, and fluorescent photoluminescence may be exhibited when irradiated with ultraviolet light. The fluorescent photoluminescence intensity may vary according to the content of the nanocrystals, which may be determined according to the concentration of the first precursor.

The first precursor compound may include PbX₂, and the second precursor may include at least one of CsX and MAX, where X=I, Br, or Cl.

Specifically, the nanocrystal may be a perovskite nanocrystal.

The perovskite nanocrystal may include 3D CsPbX₃ or 3D MAPbX₃, where MA=methyl ammonium, X=I, Br, or Cl.

The perovskite nanocrystal may include 2D PEA₂MAₙ₋₁PbₙBr₃ₙ₊₁, where MA=methyl ammonium, PEA=phenylethyl ammonium, and n=1, 2, or 3.

In addition, a dual-responsive photoencryption display according to the present disclosure may include a block copolymer (BCP) photonic crystal (PC) film with a lamellar structure in which a first layer in which a first repeating unit is positioned and a second layer in which a second repeating unit coupled with the first repeating unit is positioned are alternately stacked, a first precursor compound bonded to one of the first and second repeating units in a plurality of different regions of the block copolymer (BCP) photonic crystal (PC) film, and nanocrystals exhibiting fluorescent photoluminescence, which are dispersed in a part of the plurality of different regions and positioned in one of the first layer and the second layer.

Since the concentration of the first precursor compound doped in a first region among the plurality of different regions and the concentration of the first precursor compound doped in a second region are different from each other, the structural color generated from the first region and the structural color generated from the second region may be different.

In the block copolymer photonic crystal film, the first and second repeating units may each include a PS repeating unit and a P2VP repeating unit.

The concentration of the first precursor compound in the first region may be greater than 0 to 3 wt % or greater than 0.1 to 2 wt %, and the concentration of the first precursor compound in the second region may be 0 wt % to 0.1 wt % or 0 wt % to 0.05 wt %. By differentiating the concentration of the first precursor compound between the first region and the second region as described above, it is possible to achieve photoencryption by varying the intensity of fluorescent photoluminescence upon ultraviolet irradiation after reaction with the second precursor.

The first region and the second region may be defined by a mask layer formed on one surface of the block copolymer photonic crystal film, and the mask layer may include at least one selected from the group consisting of poly(dimethylsiloxane), Ecoflex, and room temperature vulcanizing silicone rubber (RTV).

Specifically, the nanocrystals may be formed by a reaction between the first precursor compound and the second precursor compound, and dispersed in a layer among the first and second layers in which the P2VP repeating unit is positioned.

When the nanocrystals are included as described above, structural color may be exhibited when irradiated with visible light, and fluorescent photoluminescence may be exhibited when irradiated with ultraviolet light. The fluorescent photoluminescence intensity may vary according to the content of the nanocrystals, which may be determined according to the concentration of the first precursor.

The first precursor compound may include PbX₂, and the second precursor may include at least one of CsX and MAX, where X=I, Br, or Cl.

The nanocrystals may be perovskite nanocrystals.

Specifically, the perovskite nanocrystal may include 3D CsPbX₃ or 3D MAPbX₃, where MA=methyl ammonium, X=I, Br, or Cl.

The perovskite nanocrystal may include 2D PEA₂MAₙ₋₁PbₙBr₃ₙ₊₁, where MA=methyl ammonium, PEA=phenylethyl ammonium, and n=1, 2, or 3.

In addition, a method for manufacturing a dual-responsive display according to the present disclosure may include a first step of forming a block copolymer (BCP) photonic crystal (PC) film on a substrate, a second step of doping a first precursor compound into the formed block copolymer photonic crystal film, and a third step of forming nanocrystals within the block copolymer photonic crystal film by introducing a second precursor compound which reacts with the first precursor compound into a region doped with the first precursor compound, wherein the block copolymer (BCP) photonic crystal (PC) film may have a lamellar structure in which a first layer in which a first repeating unit is disposed and a second layer in which a second repeating unit coupled to the first repeating unit is disposed are alternately stacked.

In the block copolymer photonic crystal film, the first and second repeating units may each include a PS repeating unit and a P2VP repeating unit.

The first step may include: (a) coating a solution containing a poly(styrene-block-2-vinylpyridine) (PS-b-P2VP) copolymer including the first and second repeating units onto the substrate; and (b) annealing a solvent and then quaternizing the first layer including the P2VP repeating unit using an organic compound.

The organic compound may include at least one selected from the group consisting of dibromobutane, 1-bromoethane, dichlorobutane, chloroethane, diiodobutane, and iodoethane. Specifically, the P2VP repeating unit may be crosslinked via the organic compound. More specifically, the P2VP repeating unit may have the pyridine group quaternized via the organic compound.

The second step may include doping and depositing a solution containing the first precursor compound onto the formed block copolymer photonic crystal film.

In the second step, the first precursor may include PbX₂, where X=I, Br, or Cl.

The second step may include depositing the solution containing the first precursor compound by dropwise addition onto the block copolymer photonic crystal film. Specifically, the solution containing the first precursor compound may be added dropwise for a duration ranging from greater than 0 to 500 seconds or from 20 to 300 seconds. By dropwise adding the solution for such a duration, the color of the structural color may be adjusted.

The solution containing the first precursor compound may include the first precursor compound in an amount of greater than 0 to 3 wt %, or greater than 0.1 to 2 wt %.

Between the first and second steps, the method may further include forming a mark layer on one surface of the formed block copolymer photonic crystal film to define a plurality of different regions.

The mask layer may include at least one selected from the group consisting of poly(dimethylsiloxane), Ecoflex, and room temperature vulcanizing silicone rubber (RTV).

The third step may include dropwise adding a solution containing the second precursor compound to the region doped with the first precursor compound to perform doping. Specifically, the solution containing the second precursor compound may include the second precursor compound in an amount of greater than 0 to 7 wt %, greater than 0.1 to 5 wt %, or greater than 1 to 5 wt %.

In the third step, the second precursor may include at least one of CsX and MAX, where X=I, Br, or Cl.

In addition, a method of manufacturing a dual-responsive photoencryption display according to the present disclosure may include: a first step of forming a block copolymer (BCP) photonic crystal (PC) film on a substrate; a second step of doping a first precursor compound into at least a partial region of the formed block copolymer photonic crystal film; and a third step of introducing a second precursor compound, which reacts with the first precursor compound, into at least a part of the region doped with the first precursor compound to form nanocrystals within the block copolymer photonic crystal film, wherein the block copolymer (BCP) photonic crystal (PC) film may have a lamellar structure in which a first layer in which a first repeating unit is disposed and a second layer in which a second repeating unit coupled to the first repeating unit is disposed are alternately stacked.

In the block copolymer photonic crystal film, the first and second repeating units may each include a PS repeating unit and a P2VP repeating unit.

The first step may include: (a) coating a solution containing a poly(styrene-block-2-vinylpyridine) (PS-b-P2VP) copolymer including first and second repeating units onto a substrate; and (b) annealing a solvent and then quaternizing the first layer including the P2VP repeating unit using an organic compound.

The organic compound may include at least one selected from the group consisting of dibromobutane, 1-bromoethane, dichlorobutane, chloroethane, diiodobutane, and iodoethane. Specifically, the P2VP repeating unit may be crosslinked via the organic compound. More specifically, the P2VP repeating unit may have the pyridine group quaternized via the organic compound.

The second step may include doping and depositing a solution containing the first precursor compound onto at least a partial region of the formed block copolymer photonic crystal film.

In the second step, the first precursor may include PbX₂, where X=I, Br, or Cl.

The second step may include depositing the solution containing the first precursor compound by dropwise addition onto at least a partial region of the block copolymer photonic crystal film. Specifically, the solution containing the first precursor compound may be added dropwise for a duration ranging from greater than 0 to 500 seconds or from 20 to 300 seconds. By dropwise adding the solution for such a duration, the color of the structural color may be adjusted.

The region doped with the first and second precursor compounds is a first region, and the region doped with only the first precursor compound is a second region. The concentration of the first precursor compound doped into the first region and the concentration of the first precursor compound doped into the second region are different from each other, so that the structural color generated from the first region and the structural color generated from the second region may be different.

The concentration of the first precursor compound doped into the first region may be greater than 0 to 3 wt % or greater than 0.1 to 2 wt %, and the concentration of the first precursor compound doped into the second region may be from 0 wt % to 0.1 wt %, or from 0 wt % to 0.05 wt %. By making the concentrations of the first precursor compound doped into the first region and the second region different as described above, photoencryption may be performed in a dual mode.

Between the first and second steps, the method may further include forming a mark layer on one surface of the formed block copolymer photonic crystal film to define a plurality of different regions.

The mask layer may include one or more selected from the group consisting of poly(dimethylsiloxane), Ecoflex, and room temperature vulcanizing silicone rubber (RTV).

The block copolymer photonic crystal film may include a poly(styrene-block-2-vinylpyridine) (PS-b-P2VP) copolymer, and the first and second repeating units may each include a PS repeating unit and a P2VP repeating unit.

The third step may include dropwise adding a solution containing the second precursor compound to the region doped with the first precursor compound to perform doping. Specifically, the solution containing the second precursor compound may include the second precursor compound in an amount of greater than 0 to 7 wt %, greater than 0.1 to 5 wt %, or greater than 1 to 5 wt %.

In the third step, the second precursor may include at least one of CsX and MAX, where X=I, Br, or Cl.

In addition, an encryption method according to the present disclosure may include: a first step of introducing a second precursor compound, which reacts with a first precursor compound, into at least a part of a region doped with the first precursor compound in a block copolymer photonic crystal film doped with the first precursor compound in at least a partial region, thereby inputting a code into the block copolymer photonic crystal film; and a second step of sequentially irradiating visible light and ultraviolet light onto the block copolymer photonic crystal film into which the code has been input, to read the code.

The first step may include: (a) forming a block copolymer (BCP) photonic crystal (PC) film on a substrate; (b) doping the first precursor compound into at least a partial region of the formed block copolymer photonic crystal film; and (c) forming nanocrystals within the block copolymer photonic crystal film by introducing the second precursor compound which reacts with the first precursor compound into at least a part of the region doped with the first precursor compound.

The first step may be the same as the method of manufacturing a dual-responsive photoencryption display described above.

The second step may include immersing the block copolymer photonic crystal film, into which the code has been input, in a solvent, and then irradiating visible light and ultraviolet light to read the code. Specifically, when irradiated with visible light after being immersed in ethanol, a structural color may appear, and when irradiated with ultraviolet light, fluorescent photoluminescence may occur, allowing the code encrypted in the dual-mode to be read. The solvent may include at least one selected from the group consisting of water, ethanol, methanol, propanol, and butanol, and specifically, the solvent may be ethanol.

After the second step, the encryption method may further include a third step of removing the encryption using ammonium hydroxide.

After the third step, the encryption method may further include a fourth step of re-inputting a code into the block copolymer photonic crystal film by introducing the second precursor compound, which reacts with the first precursor compound, into at least a part of the region doped with the first precursor compound in the block copolymer photonic crystal film doped with the first precursor compound, in which encryption has been removed.

Hereinafter, in order to help understand the present disclosure, examples will be described in detail. However, the following examples are merely intended to illustrate the content of the present disclosure, and the scope of the present disclosure is not limited to the following examples. Embodiments of the present disclosure are provided to more completely illustrate the present disclosure to a person having average knowledge in the art.

### EXAMPLES

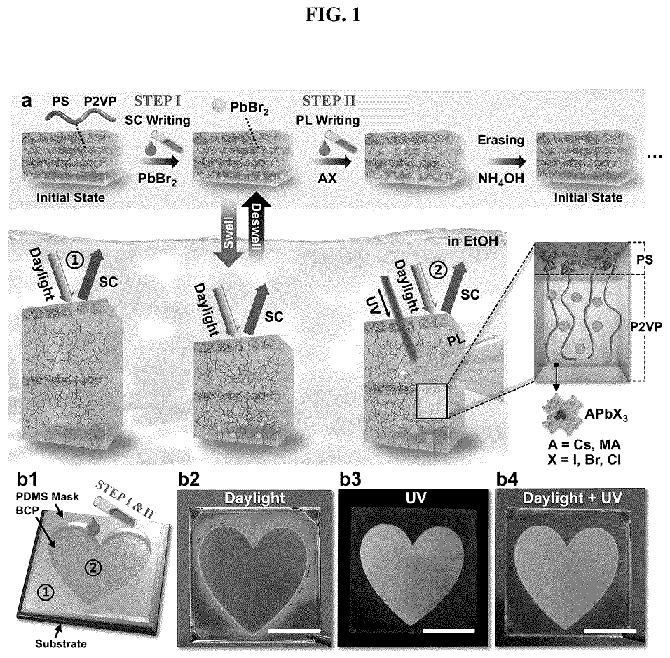

FIG. 1 shows a schematic diagram of a two-step manufacturing process of a block copolymer photonic crystal film in which perovskite nanocrystals are embedded and photographs of BCP PC films manufactured thereby according to an embodiment of the present disclosure. Specifically, in FIG. 1, (a) is a schematic diagram of a two-step manufacturing process of perovskite nanocrystals embedded in block copolymer photonic crystal films, and (b) shows photographs of BCP PC films immersed in ethanol with pattern through a two-step process under (b2) daylight, (b3) UV, and (b4) daylight and UV.

A simple but robust two-step manufacturing process for dual-responsive optical encryption is schematically illustrated in FIG. 1a. A symmetric PS-b-P2VP BCP with the number average molecular weight of 90.8 kg/mol was employed to develop a stimuli-responsive 1D PC film. A PS-b-P2VP film with ordered in-plane alternating PS and P2VP lamellae was prepared by spin coating a 7 wt % PS-b-P2VP solution in propylene glycol monomethyl ether acetate (PGMEA), followed by solvent annealing with chloroform vapor for 24 hours, yielding 1D BCP PC. A periodic arrangement of two distinct components with different refractive indices resulted in a PC exhibiting a photonic bandgap of visible range. Subsequently, the film was treated with a mixture of 1-bromoethane and dibromobutane solution in n-hexane at 60° C. for the quaternization of the pyridine groups in the P2VPdomains. Dibromobutane was employed not only to quaternize P2VP but also to crosslink the quaternized P2VP chains, allowing control of swelling of the quaternized P2VP domains in ethanol, which is a good solvent for quaternized P2VP and a poor solvent for PS. Upon immersion in ethanol, the initially transparent BCP PC film in its dry state exhibited characteristic SCs in the visible range (FIG. 1b). The SCs of BCP PC in ethanol were readily controlled by the degree of cross-linking of the quaternized P2VP domains with dibromobutane, and fully visible SCs were obtained with different amounts of dibromobutane.

To further control the SC of a BCP PC set by a given bromoethane and dibromobutane treatment, a few drops of a PbBr₂ solution in methanol, a precursor of perovskite nanocrystals, were deposited on the BCP PC film. The solution drops readily diffused into the film, particularly into the quaternized P2VP domains, rendering PbBr₂ coordinated with the quaternized P2VP chains by Lewis acid-base interactions, as illustrated in STEP I (or a “first step”) in FIG. 1a. When the PbBr₂-treated BCP PC was swollen in ethanol, the SC of the film was blue-shifted from the initial SC owing to the reduced solvation affinity of PbBr₂-associated quaternized P2VP against ethanol compared with that of neat quaternized P2VP, which is consistent with previous results (bottom middle schematic diagram of FIG. 1a). In STEP II (or a “second step”), for PL writing, other perovskite nanocrystal precursor counterparts (AX; A=Cs, MA; X=I, Br, Cl) dissolved in methanol were applied to the PbBr₂ treated film. AX preferentially diffused into the PbBr₂-coordinated quaternized P2VP domains and instantly reacted (crystallized) with PbBr₂, giving rise to perovskite nanocrystals that were selectively confined in the quaternized P2VP domains. Depending on the AXs, a variety of perovskite nanocrystals, such as MAPbX₃ (X=I, Br, Cl) and CsPbX₃ (X=I, Br, Cl), were synthesized in the BCP PC, as will be described in detail later. The successful synthesis of perovskite nanocrystals in the BCP PC was confirmed by the characteristic PL of the perovskite nanocrystals under UV irradiation. PL also appeared under UV light when the perovskite nanocrystal-loaded BCP PC film was swollen in ethanol, as shown in the bottom right schematic diagram of FIG. 1a. In this situation, the characteristic SC programmed with PbBr₂ and PL of the perovskite nanocrystals was visible under daylight and UV light, respectively. The synthesized perovskite nanocrystals and residual precursors in the BCP PC were dissolved by treating the film with NH₄OH, restoring the BCP PC written in SC and PL to pristine PC without any precursors, as illustrated in FIG. 1a.

Dual writing of the SC and PL with PbBr₂ and perovskite nanocrystals in a BCP PC was performed, and the results are shown in FIG. 1b. First, a heart-shaped symbol was printed with a PbBr₂ solution on a BCP PC whose initial red SC was set with a proper amount of bromoethane and dibromobutane, followed by printing the same heart area with a CsBr solution, as shown in FIG. 1b1. When the BCP PC programmed with the two precursors was immersed in ethanol, a heart symbol with a blue SC appeared, whereas the remaining area appeared red, as shown in FIG. 1b2. A heart symbol with characteristic bright green PL was clearly visualized upon UV exposure, which implied the successful synthesis of perovskite nanocrystals in the BCP PC, as shown in FIG. 1b3. Under UV irradiation, the bluish heart arising from the programmed SC of the BCP PC immersed in ethanol changed to a greenish PL heart because the PL intensity of the programmed heart regions with perovskite nanocrystals was stronger than that of the SC of the film, as shown in FIG. 1b4. The independent control of SC and PL in a BCP PC with perovskite nanocrystals preferentially synthesized in the quaternized P2VP domain allowed the development of dual-mode high-security optical encryption, as will be described later.

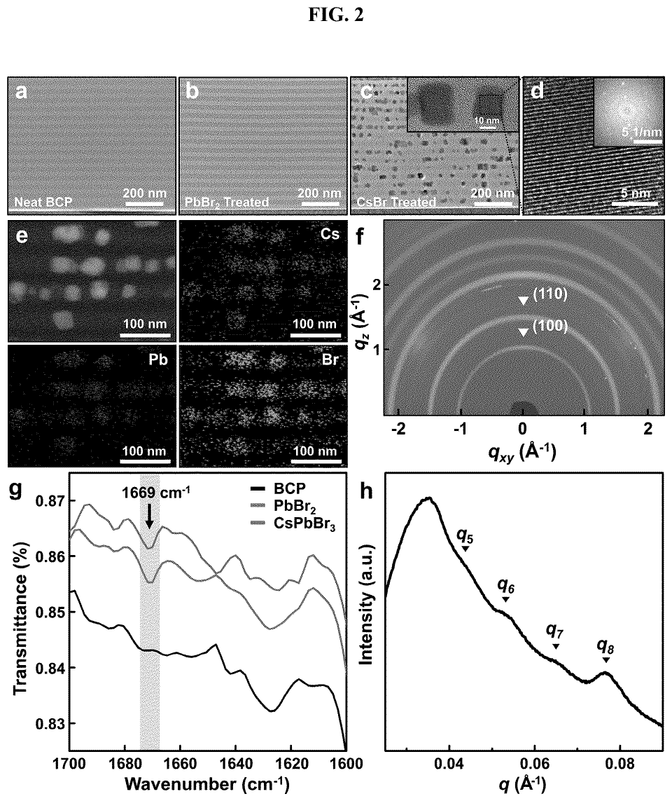

FIG. 2 shows molecular structures and microstructures of BCP PC with perovskite nanocrystals according to an embodiment of the present disclosure and comparative examples, which were examined using various techniques. Specifically, FIG. 2 shows cross-sectional TEM images of BCP PC films in (a) original state, (b) after application of PbBr₂ in STEP I, 5 and (c) after crystallization of CsPbBr₃ in STEP II. (d) HR-TEM image and its fast Fourier transform pattern of CsPbBr₃ nanocrystal embedded in BCP PC film are shown. (e) Magnified TEM image and EDS mapping images of Cs, Pb, and Br are shown. (f) GIWAXS pattern of CsPbBr₃ embedded in BCP PC film is shown. (g) FT-IR transmittance spectra of the pristine BCP film and the films with PbBr₂ treatment and further CsBr treatment is shown. (h) 1D horizontal plot of GISAXS pattern of BCP PC films with embedded CsPbBr₃ nanocrystals is shown.

The molecular structures and microstructures of neat BCP PC, PbBr₂-treated BCP PC, and BCP PC with perovskite nanocrystals were examined using various techniques, such as focused ion beam-assisted cross-sectional transmission electron microscopy (TEM) combined with energy dispersive X-ray spectroscopy (EDX), X-ray scattering, and Fourier transform infrared (FT-IR) spectrometry, as shown in FIG. 2. Highly ordered alternating in-plane lamellae of PS and quaternized P2VP were formed after solvent vapor annealing followed by quaternization, as shown in FIG. 2a. The periodicity of the lamellae was about 60 nm, with both PS and quaternized P2VP having a periodicity of about 30 nm arising from the symmetric composition of the BCP. The ordered lamellae were confirmed by grazing incidence small-angle X-ray scattering (GISAXS). The 1D plot of the GISAXS pattern along the q_{z} direction exhibited a series of peaks with characteristic qₙ/q₁ ratios of integer multiples, indicating in-plane lamellae with a periodicity of 56 nm. When the BCP PC film was treated with PbBr₂, the orientation of the highly ordered in-plane lamellae was rarely altered, as shown in FIG. 2b. Notably, the PbBr₂-treated quaternized P2VP domains appeared darker in TEM than in the neat BCP film because of the enhanced electron beam contrast due to the incorporation of Pb atoms with high electron densities in the domains. The PbBr₂-treated BCP film also showed greater scattering contrast in the GISAXS pattern than the neat BCP film because of the enhanced scattering density of the Pb atoms in the quaternized P2VP domains.

After STEP II, which involved the treatment of the PbBr₂-containing BCP PC film with CsBr, CsPbBr₃ nanocrystals, about 20 nm in size, were preferentially synthesized in the quaternized P2VP domains of the ordered in-plane lamellae, as shown in FIG. 2c. The inset of FIG. 2c clearly shows the development of square-shaped perovskite nanocrystals. In contrast to the interior of the film, only a few CsPbBr₃ crystals were observed on the surface of the film, owing to the absence of interactions between CsPbBr₃ and the top PS layer. The unique surface texture on the BCP surface arose from the mechanical buckling of a top PS lamellae during swelling and de-swelling of the underneath P2VP lamellae, rarely altering the optical properties of the BCP PC due to the presence of the surface texture. The high-resolution TEM image in FIG. 2d shows the characteristic lattice of CsPbBr₃, and the single-crystal structure of cubic-phase CsPbBr₃ can be confirmed from the fast Fourier transform image of the high-resolution TEM image in the inset of FIG. 2d. The EDS mapping results shown in FIG. 2e verify the successful synthesis of CsPbBr₃ nanocrystals in the quaternized P2VP domains. The lamellar nanostructure and CsPbBr₃ nanocrystals uniformly developed over a micron-scale area during the entire process. The characteristic X-ray energies corresponding to the Cs, Pb, and Br atoms are apparent in the EDX images in FIG. 2e. The grazing incidence wide-angle X-ray scattering (GIWAXS) results of the BCP film containing perovskite nanocrystals in FIG. 2f also confirmed the development of CsPbBr₃ nanocrystals in the film. The pattern exhibited diffraction peaks at q=1.1 and 1.53 Å⁻¹, corresponding to the (1 0 0) and (1 1 0) planes of the cubic CsPbBr₃ crystal structure, respectively.

The inventors speculated that the preferential incorporation of PbBr₂ and CsPbBr₃ in the quaternized P2VP domains resulted from the Lewis acid-base coordination associated with the delocalization of the lone pair of electrons at the N atoms of the quaternized P2VP blocks to the 6p empty orbitals of Pb2⁺. The Lewis acid-base interactions were confirmed by FT-IR spectroscopy, and the results are shown in FIG. 2g. When PbBr₂ was employed in a BCP PC film, a new shoulder appeared approximately at 1669 cm⁻¹, corresponding to the pyridine ring-Pb2⁺ bond vibration. An absorption peak was also apparent for the perovskite nanocrystal-containing BCP film, corroborating the inventors' hypothesis. Both the orientation and domain dimensions of the in-plane lamellae of the perovskite nanocrystal-containing BCP PC film were almost identical to those of the neat and PbBr₂-treated BCP film (FIG. 2h), as confirmed by the GISAXS results.

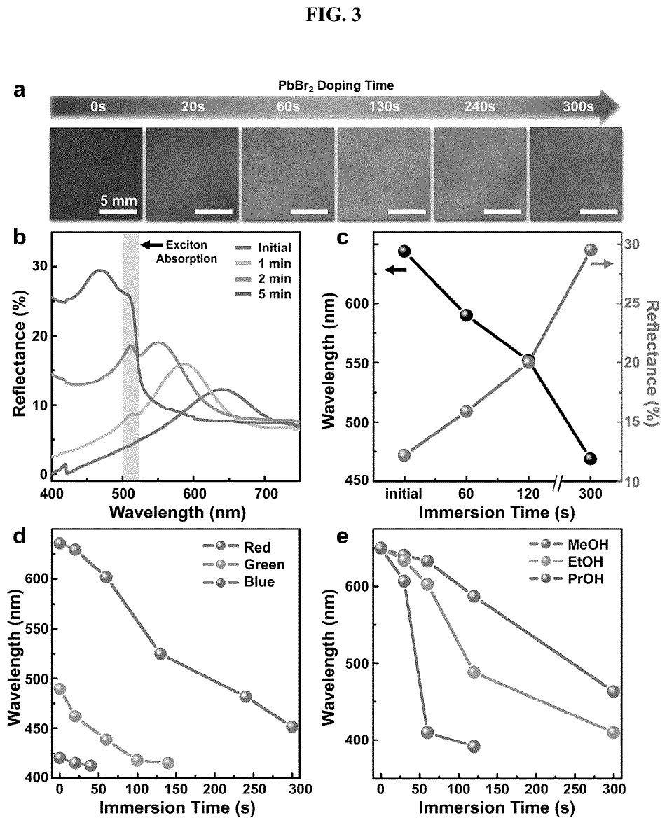

FIG. 3 shows preferential doping of PbBr₂ into the quaternized P2VP domains of the BCP PC film to control the structural color of the BCP PC and the results according to an embodiment of the present disclosure. Specifically, in FIG. 3, (a) shows photographs of SCs of BCP PC films swollen in ethanol as a function of the PbBr₂ treatment time. (b) Reflectance spectra of CsPbBr₃ embedded BCP PC films with different PbBr₂ treatment times. (c) A plot of peak wavelength and reflectance of CsPbBr₃ embedded BCP PC films as a function of the PbBr₂ treatment time. Wavelength of peak reflectance of BCP PC films as a function of the PbBr₂ treatment time with (d) various initial SC films and (e) various swelling agents.

The preferential doping of PbBr₂ into the quaternized P2VPdomains of the BCP PC film allowed control of the SC of the BCPPC (STEP I in FIG. 1a), and the results are shown in FIG. 3. To reveal how PbBr₂ affected the SC of the BCP PC, the SC of the film was monitored as a function of the exposure time of the BCP film to a PbBr₂ solution. BCP PC films with their initial red SC set by the appropriate amounts of bromoethane and dibromobutane were exposed to the PbBr₂ solution for different time periods of up to 300 seconds. When the PbBr₂-treated BCP films were immersed in ethanol, various SCs appeared depending on the PbBr₂ exposure time, as shown in the series of photographs in FIG. 3a. The initial red SC of the BCP PC gradually blue-shifted with PbBr₂ exposure, giving rise to a blue SC at an exposure time of 300 seconds. The blue shift in the SC with PbBr₂ arose from the reduced solvation affinity of the quaternized P2VP blocks to ethanol due to the presence of nearly insoluble PbBr₂ in ethanol coordinated with quaternized P2VP chains. The reduced solvation affinity resulted in reduced swelling of the quaternized P2VP domains when immersed in ethanol, giving rise to a blue shift in the SC of BCP PC.

The treatment of PbBr₂ with BCP PC offered a convenient route for controlling its SC in the full visible range, as shown by the UV-vis spectroscopy results in FIG. 3b. The exposure time of PbBr₂ to a BCP PC was varied in the range of 0-300 seconds. The initial SC with a maximum reflection wavelength of about 644 nm changed to one with a wavelength of about 467 nm (FIG. 3c). Notably, a significant increase in the reflectance of SC was observed in proportion to the time of the PbBr₂ treatment. BCP PCs often suffer from relatively low SC reflectivity due to the small refractive index contrast between the two constituent PS and quaternized P2VP domains (n_{PS}≈n_{P2VP}≈1.6). The selective incorporation of PbBr₂, which has a high refractive index (n_{csPbBr3}≈2.55) in the visible range, effectively enhanced the refractive index contrast between two alternating lamellae, resulting in the high reflectance of a PbBr₂-treated BCP PC at 300 seconds that was twice that of a pristine BCP film, as shown in FIG. 3c.

The control of the SC of the BCP PC by PbBr₂ treatment was also examined using BCP PC films with different initial SCs, and the results are shown in FIG. 3d. For this purpose, two representative BCP PC films with initial green and blue SCs and maximum reflection wavelengths of 490 and 420 nm, respectively, were fabricated by adjusting the amounts of bromoethane and dibromobutane. Both BCP PC films were blue-shifted in the SC upon PbBr₂treatment, which was consistent with the results for the red SCBCP PC film (FIG. 3a). The blue shift in the SC of a PbBr₂-treated BCP PC arising from the reduction of the ethanol solvation affinity in the quaternized P2VP domains was also observed with other quaternized P2VP domain-swelling solvents, such as methanol and 1-propanol, as shown in FIG. 3e. The reduced solvation affinity of PbBr₂-treated BCP PC to 1-propanol was most prominent, causing the initial red SC of the film to blue-shift to a blue SC with PbBr₂ treatment for just 50 seconds. However, the blue shift in the SC of the BCP PC with an initial red SC was marginal in methanol after 50 seconds of PbBr₂ treatment (FIG. 3e). These results imply that the reduction in the solvation affinity of methanol was the least among the three solvents, which was consistent with the results of previous studies showing that the solvation affinity decreased with the alkyl chain in the alcohol series.

The SC of a BCP PC programmable by controlling the PbBr₂ treatment time in the full visible range was rarely altered after the subsequent CsBr treatment in STEP II, involving the synthesis of CsPbBr₃ nanocrystals. However, new absorption peaks appeared at ≈511 nm in the UV-vis spectra of the BCP PC films containing CsPbBr₃ nanocrystals (FIG. 3b). The absorption peaks were attributed to the characteristic exciton absorption of CsPbBr₃, suggesting the successful synthesis of perovskite nanocrystals in BCP PC. The facile control of SC in the full visible range by PbBr₂ treatment on a BCP PC could provide an efficient method for encrypting and deciphering information. Further, the PL arising from the perovskite nanocrystals synthesized in the PbBr₂-treated BCP PC could further broaden the encryption capability, leading to a novel dual-mode SC and PL encryption platform, as will be described later.

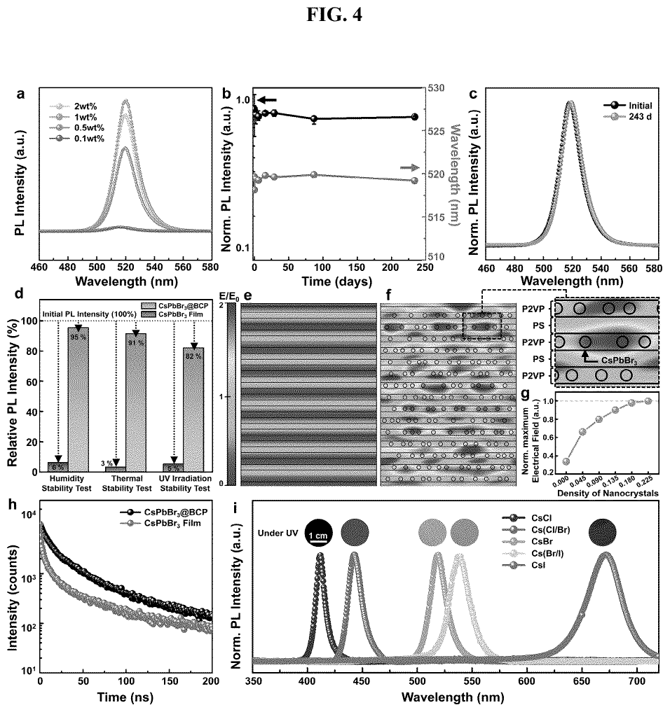

FIG. 4 shows results of examining photophysical properties of CsPbBr₃ nanocrystals synthesized in quaternized P2VP lamellae through the first step (STEP I) and the second step (STEP II) using steady-state and time-resolved PL spectroscopy according to an embodiment of the present disclosure. Specifically, in FIG. 4, (a) shows steady-state PL spectra of the CsPbBr₃ embedded BCP PC films with different concentrations of CsBr for STEP II. (b) A plot of the PL intensity and maximum PL wavelength of the film under ambient conditions as a function of time. (c) Normalized steady-state PL spectra of the film under ambient conditions over 243 days. (d) PL stability of CsPbBr₃ embedded BCP PC under 70% of relative humidity, 130° C. of temperature, and UV irradiation. Simulated results of electric field distribution of (e) BCP PC without perovskite nanocrystals and with (f) CsPbBr₃ nanocrystals preferentially in P2VP layer. (g) Normalized maximum electrical field values with different doping density of perovskite nanocrystals. (h) Time-resolved PL decay profiles of pristine CsPbBr₃ thin film and CsPbBr₃ embedded in BCP PC film. (i) Steady-state PL spectra of perovskite nanocrystals embedded in BCP PC films with different halide compositions.

The photophysical properties of the CsPbBr₃ nanocrystals synthesized in the quaternized P2VP lamellae through STEPs I and II were examined using steady-state and time-resolved PL spectroscopy, and the results are shown in FIG. 4. In STEP II (FIG. 1A), PbBr₂ loaded in the quaternized P2VP domains immediately crystallized with its perovskite precursor counterparts (CsX; X=I, Br, Cl), giving rise to various CsPbX₃ (X=I, Br, Cl) nanocrystals preferentially located in the quaternized P2VP lamellae. The perovskite nanocrystals in the quaternized P2VP domains were determined by controlling either the PbBr₂ treatment time at a given CsX concentration or the CsX concentration at a given PbBr₂ treatment time. The present inventors investigated the PL properties of BCP PC films treated with PbBr₂ for 300 seconds (the condition for maximum loading of PbBr₂), as a function of the concentration of CsBr. When the films were exposed to incident UV light (wavelength of 350 nm), characteristic PL instantly appeared at a wavelength of about 511 nm. As expected, the PL intensity of the films gradually increased as the CsBr concentration increased to 1 wt %, above which the intensity saturated, as shown in FIG. 4a. In addition, as a result of XRD analysis, it was confirmed that no by-products such as CsPb₂Br₅ were produced even when the exposure time of PbBr₂ was increased. No characteristic XRD reflections corresponding to the tetragonal crystals of CsPb₂Br₅ were observed after synthesis of CsPbBr₃ in all the samples with different PbBr₂ exposure times from 5 min up to 120 min. The inventors believe that the PbBr₂ loading in a BCP PC was limited due to its low solubility in methanol even after the long exposure time. In addition, the total number of PbBr₂ in quaternized P2VP matrix was also limited owing to the coordination sites of quaternized P2VP with PbBr₂. The limited doping of PbBr₂ in BCP was indirectly confirmed with the structural color of a BCP PC as a function of PbBr₂ exposure time. The blue-shift of BCP SC arising from the coordination of PbBr₂ with P2VP chain was saturated after 30 min exposure, and further blue-shift of the SC was rarely observed even after 120 min exposure.

The PL intensity of the CsPbBr₃ synthesized in the BCP PC films was much higher than that of neat CsPbBr₃ film and CsPbBr₃ nanocrystals embedded in a P2VP matrix (aCsPbBr₃/P2VP composite). The CsPbBr₃ nanocrystals preferentially synthesized in the quaternized P2VP lamellae exhibited a PL quantum yield of about 33.7%, much higher than that of a neat CsPbBr₃ film (˜0.1%). It should be noted that significantly low PL quantum yield of neat CsPbBr₃ film less than 1% was also reported in previous studies. The PL quantum yield of a CsPbBr₃ film could be substantially enhanced by additional crystal engineering strategies such as organic ammonium treatment, polymer additive, stoichiometric engineering, and elemental ion doping. As CsPbBr₃ nanocrystals according to the present disclosure were synthesized in a BCP PC without an additional crystal engineering treatment, the inventors compared the PL quantum yield of the CsPbBr₃ in the BCP PC with that of an as-cast CsPbBr₃ film. The significantly enhanced PL quantum yield of the CsPbBr₃ nanocrystals in the BCP PC was attributed to the efficient passivation of the defective trap sites on the surface of CsPbBr₃ with quaternized P2VP chains in the lamellae. Further, the PL quantum yield of the perovskite nanocrystals in BCP PC was enhanced owing to the reduced nanocrystal size during confined crystallization, which promoted more favorable excitonic recombination.

In addition to the significantly enhanced PL quantum yield of the CsPbBr₃ nanocrystals in BCP PC films, the perovskite nanocrystals exhibited excellent environmental stability, with the initial PL intensity as well as peak position (wavelength) maintained over 8 months under ambient conditions of relative humidity of 30-50% and 25° C., as shown in FIGS. 4b and 4c. Further, PL stability tests under harsh conditions were performed as shown in FIG. 4d. The CsPbBr₃ embedded BCP PC film maintained 95% of its initial PL intensity, while only 6% of the initial PL intensity was retained for the neat CsPbBr₃ film after exposure to 70% of relative humidity at 20° C. for 72 hours. Notably, the CsPbBr₃ embedded BCP PC also exhibited excellent PL stability under UV irradiation as well as high temperature of 130° C. for 24 hours. The results in FIG. 4d show that the efficient surface passivation of CsPbBr₃ nanocrystals with quaternized P2VP blocks significantly enhanced the environmental stability of the perovskite nanocrystals. Especially, CsPbBr₃ embedded BCP PC showed no change of PL emission wavelength even after the thermal treatment at 130° C. for 24 hours. The excellent environmental stability arose not only from the efficient defect passivation of the CsPbBr₃ nanocrystals by the quaternized P2VP blocks but also from the physical confinement of the perovskite nanocrystals in the quaternized P2VP domains, each of which was encapsulated with adjacent hydrophobic PS layers in the self-assembled 1D PC nanostructure.

In addition, the PL enhancement of the perovskite nanocrystals in BCP PC arose from the local-field enhancement of CsPbBr₃ induced by Mie resonance in the BCP PC film. Numerical simulations of the near-field distribution at 365 nm were conducted to investigate the local field enhancement of BCP PC without and with CsPbBr₃ nanocrystals, and the results are shown in FIGS. 4e and 4f, respectively. In the simulation, the dimensions of the lamella structure of PS-b-P2VP and perovskite nanocrystals were chosen from cross-sectional TEM image. The resonance of the electrical field was clearly observed in the BCP PC film with perovskite nanocrystals (FIG. 4f), while no local-field enhancement was observed in bare BCP film (FIG. 4e). Further, the maximum resonance of electrical field was increased as a function of the doping density of perovskite nanocrystals (FIG. 4g). The inventors also observed that the maximum electrical field was saturated at high doping density, consistent with the results in FIG. 4a.

To verify the hypnosis of PL quantum yield enhancement, time-resolved PL spectroscopy experiments were performed using the time-correlated single-photon counting technique, and the results are shown in FIG. 4h. These results supported the inventors' speculation that the trap sites on the surface of the CsPbBr₃ crystals were effectively passivated by the quaternized P2VP chains through Lewis acid-base interactions, leading to an enhanced PL quantum yield of the CsPbBr₃ nanocrystals in the BCP PC films.

Moreover, the perovskite nanocrystals that self-assembled in the BCP PC (FIG. 2c) were resistant to polar solvents. The BCP PC film immersed in ethanol for 5 hours retained 50% of its initial PL intensity. The outstanding PL stability of the perovskite nanocrystals containing the BCP PC film in ethanol allowed the reliable evolution of the SC of the film in ethanol without significantly harming the PL of the film, making it suitable for dual-mode (SC and PL) optical encryption, as will be described later. Repetitive swelling in ethanol and deswelling of perovskite nanocrystals containing the BCP PC film were performed for more than ten cycles without significant degradation in the PL of the film. PL spectra at different wavelengths were readily obtained in the two-step synthesis of perovskite nanocrystals in a BCP PC. By simply mixing the CsX (X=I, Br, Cl) precursors in the solution for crystallization (STEP II), CsPbX₃ nanocrystals with tunable halide compositions were obtained, as shown in FIG. 4i. The PL spectra were tuned from 411 to 672 nm by varying the composition of the halides, enabling visible spectral region. The 2D GIWAXS patterns confirmed the successful synthesis of various CsPbX₃ nanocrystals with mixed halide compositions in the BCP PC films. Further, the composition of perovskite nanocrystals could also be simply changed with different AX precursors in the STEP II. Various perovskite nanocrystals such as MAPbX₃ (X=I, Br, Cl) and PEA₂MAₙ₋₁Pb_{N}Br₃ₙ₊₁ with n=1, 2, and 3 were synthesized in BCP PC with the characteristic PL emission colors. Therefore, the PL encryption and decryption system could be operated in a wide range of colors with various perovskites, as summarized in Table 1.

TABLE 1

| | A site | X site | PL emission wavelength (nm) |
|---|---|---|---|
| 3D | Cs | Cl | 411 |
| Perovskites | | Br | 518 |
| | | I | 672 |
| | MA | Cl | 398 |
| | | Br | 522 |
| | | I | 718 |

| | | | Layer | PL emission |
|---|---|---|---|---|
| | A, X | Spacer | thickness | wavelength |
| | site | (A′ site) | (value of n) | (nm) |
| 2D | MABr | Phenylethyl | 3 | 513 |
| Perovskites | | ammonium | 2 | 493 |
| | | (PEA) | 1 | 409 |

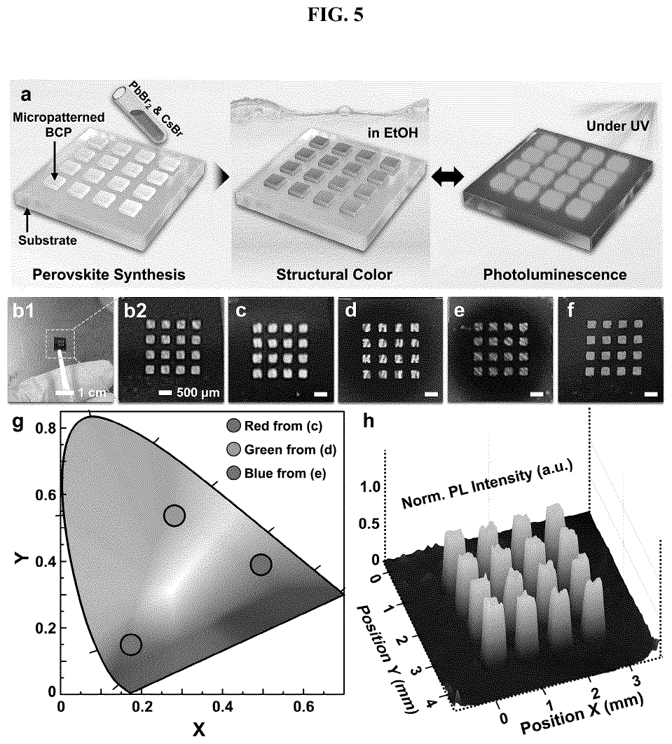

FIG. 5 shows that an SC and PL dual-mode BCP PC film may encode or decode much complicated information for highly sophisticated anti-counterfeiting system through micro-patterning according to an embodiment of the present disclosure. Specifically, in FIG. 5, (a) shows schematic illustration of the manufacture of a micro-patterned BCP PC film with SC and PL. Photographs of micro-patterned BCP PC films under (b) daylight, in ethanol with (c) red, (d) green, and (e) blue SCs, and (f) UV light. (g) CIE coordinates of SCs from (c) to (e). (h) PL intensity mapping from (f).

The SC and PL dual-mode BCP PC film according to the present disclosure can be micro-patterned that can encode or decode much complicated information for highly sophisticated anti-counterfeiting system, as shown in FIG. 5. First, a micro-patterned bare BCP PC film was prepared as reported in the previous research. CsPbBr₃ nanocrystals were subsequently synthesized in the micro-patterned BCP PC film by following the same method as shown in FIG. 1. As a result, it was confirmed that a micro-patterned SC and PL dual-mode BCP PC film, as shown in FIG. 5b, was fabricated. The SEM image and EDS element mapping for C, Pb, and Br confirmed the successful fabrication of a micro-patterned BCP with perovskite nanocrystals. As shown in FIG. 5c to 5e, it was apparent that the SC of the micro-patterned SC and PL dual-mode film was adjusted to red, green, and blue by controlling the PbBr₂ doping time from 30 to 300 seconds (FIG. 3a). In addition, the intensive green PL emission was evident from the film when the film was exposed to UV light (FIG. 5f). As shown in FIG. 5g, the PbBr₂ doping time-dependent red, green, and blue SCs from micro-patterned SC and PL dual-mode films were confirmed. 1D line PL intensity measurement showed the PL emitted only from the micro-patterned regions. Further, normalized PL intensity 2D mapping shows the micro-patterned PL from the patterned BCP with perovskite nanocrystals (FIG. 5h).

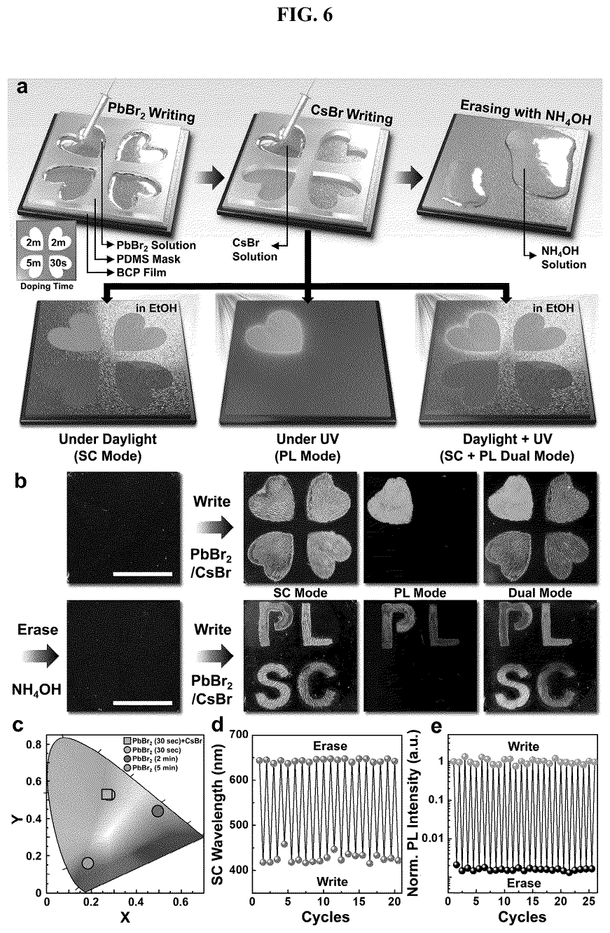

FIG. 6 illustrates writing of SC and PL, removal using an ammonia solution, and repetitive writing/removal according to an embodiment of the present disclosure. Specifically, in FIG. 6, (a) shows a schematic diagram of a sequential process of writing with SC, PL and erasing with ammonia solution. (b) Photographs of different images produced by repetitive writing and erasing of CsPbBr₃ nanocrystals, which are read by ethanol exposure under daylight, UV, and their combination. (c) CIE coordinates of SC from four hearts of the BCP PC film from (b). (d) Variation of wavelength values at the maximum reflection upon repetitive treatments of writing and erasing with NH₄OH. (e) Normalized PL intensity of CsPbBr₃ nanocrystals as a function of writing/erasing cycles.

The selective writing of programmed SCs and PLs was accomplished using STEP I and sequential STEP I and II, respectively, as schematically shown in FIG. 6a. More importantly, both the SC and PL information programmed by the two-step processes were readily erased by treatment with NH₄OH solution (FIG. 6a). A laser-cut poly(dimethyl siloxane) (PDMS) film was used as a stencil pattern mask for spray coating. The PDMS mask was conformally placed on a BCP PC film, followed by the spray coating of a PbBr₂ solution on the PDMS/BCP PC film with doping times ranging from 30 to 300 seconds (leftmost scheme in FIG. 6a). In this process, various SCs could be programmed on a BCP PC film immersed in ethanol. Subsequent CsBr loading on some of the PbBr₂-patterned areas allowed for the immediate synthesis of CsPbBr₃ nanocrystals on the deposited regions (middle scheme of FIG. 6a). When the programmed BCP PC with PbBr₂ and CsBr was immersed in ethanol, various SCs appeared depending on the doping time, which controlled the swelling of the quaternized P2VP lamellae due to the doping time-dependent solvation affinity of the quaternized P2VP domains (the leftmost scheme in the 2nd row in FIG. 6a). In addition, a characteristic PL in the regions selectively written with CsBr developed in the dried BCP PC film under UV exposure (middle scheme in the 2nd row in FIG. 6a). As expected, both SCs and PLs were observed when the programmed BCP PC film was immersed in ethanol under UV exposure (rightmost schematic in the 2nd row in FIG. 6a). Interestingly, the doped PbBr₂ and synthesized CsPbBr₃ nanocrystals were readily dissolved by NH₄OH treatment, making our SC and PL dual-mode BCP PC displays rewritable, as schematically shown in FIG. 6a.

Rewritable SC and PL dual-mode BCP PCs were successfully developed, as shown in FIG. 6b. A patterned BCP PC spray coated with PbBr₂ and CsBr exhibited four different heart-shaped SCs, depending on the doping time of PbBr₂ when immersed in ethanol. As shown in FIG. 6c, each heart exhibited characteristic red, green, and blue SCs depending on the PbBr₂ doping time. Only one heart pattern appeared in the PL when the dried BCP PC film was exposed to UV light, suggesting the successful synthesis of CsPbBr₃ nanocrystals in the heart regions. When the BCP PC film immersed in ethanol was exposed to UV, three additional hearts were visualized in the SC. The green SC information on the upper left heart, showing the characteristic PL among the four hearts of the BCP PC film, was rarely recognized because the PL emission of the heart arising from the CsPbBr₃ nanocrystals was much stronger than the reflection from the SC. The BCP PC film was restored to its initial state by the NH₄OH treatment of the film for 1 min, which efficiently dissolved both the PbBr₂ and CsPbBr₃ nanocrystals without altering the ordered BCP lamellae. Additional XRD analysis was performed to characterize not only CsPbBr₃ crystals but also possible byproducts embedded BCP PC films before and after NH₄OH solution treatment. The characteristic XRD peaks of CsPbBr₃ totally disappeared after NH₄OH solution treatment, implying complete decomposition and removal of perovskite nanocrystals. Further, no XRD peaks arising from by-products, such as orthorhombic Pb(OH)₂, Pb(OH)Br, or tetragonal CsPb₂Brₛ crystals, at 2θ°=21.430 and 11.74°, respectively, were not found after NH₄OH solution treatment. The development of CsPbBr₃ crystals in the BCP PC after 2nd writing step and the subsequent dissolution of CsPbBr₃ crystals with NH4OH were again confirmed in the XRD results. No trace of the possible byproducts was also observed in the 2nd erased film. It was confirmed that enough NH₄OH solution utterly dissolved all perovskite precursor ions, such as Cs⁺, Pb²⁺, and Br⁻, giving rise to complete removal of perovskites without leaving any other byproducts. Subsequently, four alphabets, “P,” “L,” “S,” and “C,” were written with a PbBr₂ solution having different doping times of 300, 120, 60, and 30 seconds, respectively. The alphabets “P” and “L” were additionally treated with CsBr, giving rise to the synthesized CsPbBr₃ nanocrystals in the regions of the alphabets. Again, depending on the reading conditions (immersion in ethanol, UV exposure, and UV exposure on an immersed film in ethanol), the dual-mode SC and PL information was successfully visualized on the programmed BCP PC, as shown in the 2nd row in FIG. 6b.

To examine the durability of the process after multiple writing and erasing cycles, we prepared a BCP PC film with an initial maximum SC reflectivity of 650 nm. The wavelength of the maximum reflectance shifts to about 400 nm after the two-step process because of the reduced swelling of the quaternized P2VP domains arising from the doped PbBr₂ and CsPbBr₃ nanocrystals. The wavelength at the maximum reflection recovered to about 650 nm after NH₄OH treatment (FIG. 6d). As shown in the FIG. 6d, variations in the wavelength of SC were observed after the writing and erasing steps, showing the reliability of SC confirmed after 20 writing, reading, and erasing cycles. Reliable writing, reading, and erasing of the PL information could also be performed after 20 cycles of synthesis and dissolution of the CsPbBr₃ nanocrystals, as shown in FIG. 6e.

For real implementation of our rewritable system, production cost based on preparation time was estimated. A thin BCP PC film with the ordered in-plane lamellae was fabricated by spin-coating a BCP solution, followed by solvent annealing for 24 hours and quaternization in a mixture of dibromobutane and bromoethane for 24 hours. It should be noted that a BCP PC is mass producible, scalable, and reusable because our encryption is rewritable. In each BCP PC film, writing SC as well as PL is characterized as a fast process less than 5 and 1 min, respectively. The process of reading SC can be done within 10 seconds. The reading of PL occurs instantaneously. The entire write-read one cycle takes less than 8 min maximum, including 1 min of erasing step with NH₄OH. Therefore, when the day-long process time taken during the BCP PC film fabrication can be supplemented through solution-based mass production, it is noteworthy that the whole steps utilizing the display are simple and fast from the user's point of view. This is particularly significant, considering that commercially used meta surface-based hologram technology for encryption entails expensive manufacturing processes such as photolithography and ion-beam etching, requiring more complex fabrication steps. The cost effectiveness was further investigated to evaluate the potential applicability of the system according to the present disclosure in industrial market.

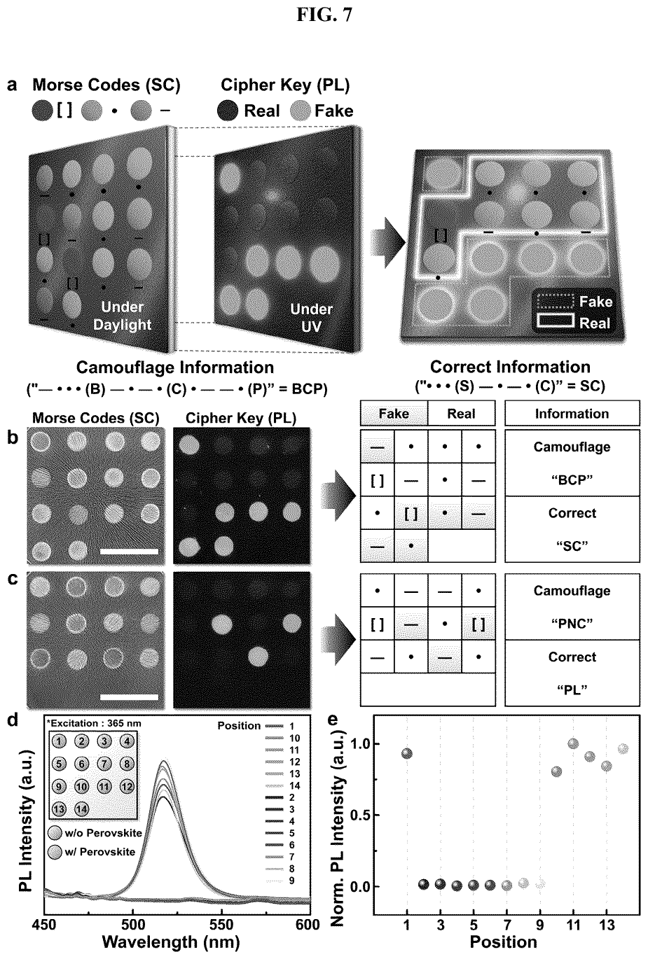

FIG. 7 shows that a rewritable dual-mode BCP PC display according to an embodiment of the present disclosure was successfully employed in a proof-of-concept encryption platform for a Morse code-based high-security-level rewritable optical encryption. Specifically, in FIG. 7, (a) shows schematic illustration of dual-responsive optical encryption using SC and PL. At first, camouflage information (BCP) appears by immersing the films in ethanol. Then, the correct information (SC) is deciphered with PL. (b), (c) SC arrays with combinations of real and fake signals with a PL as a cipher key. Two cases are implemented in one film by rewritable process, which reads (b) BCP/SC and (c) PNC/PL corresponding to camouflage/correct information, respectively (PNC stands for perovskite nanocrystal). All the scale bars are 1 cm. (d) PL spectra of Morse code circles on SC and PL dual-mode BCP PC encryption display (inset: position of local PL intensity measurement). (e) PL intensities from PL spectra of (d).

A rewritable dual-mode BCP PC display that enables independent control of SC and PL according to the present disclosure was successfully employed in a proof-of-concept encryption platform for a Morse code-based high-security-level rewritable optical encryption. The results are shown in FIG. 7. Morse code is a method used in telecommunications to encode text characters as standardized sequences of two different signal durations, called dots and dashes, or dits and dahs. International Morse code encodes 26 basic Latin letters (A through Z), Arabic numerals, and a small set of punctuation and procedural signals. The letters of a word are separated by a space of duration equal to three dits, and words are separated by a space equal to seven dits. As Morse code can be programmed and sent in a form perceptible to the human senses, for example, via sound waves or visible light, we designed an SC-based Morse code system in which the three representative SCs, red, green, and blue, of a BCP PC film were used as the “space between signals,” “dots,” and “dashes,” respectively, in Morse code, as schematically shown in FIG. 7a. The three Morse code units were readily set with the red, green, and blue SCs of a BCP PC programmed with controlled doping of PbBr₂. For instance, the alphabets of “B,” “C,” and “P” with Morse codes of “-⋅⋅⋅(B)[ ]-⋅-⋅(C)[ ]⋅- -⋅(P)” were written in SC with “(blue, green, green, green) (B) (red), (blue, green, blue, green) (C) (red) (green, blue, blue, green) (P).” The alphabets “B,” “C,” and “P” were written with the appropriate doping of PbBr₂ in a BCP PC, and the alphabets were encoded in SCs when the film was immersed in ethanol (the leftmost scheme of FIG. 7a).

To enhance the security of the system, cipher-key information based on PL, which validates the authenticity of signals, was adopted in the SC-based Morse code display. For example, fake PL information was assigned as a luminous validity tag by synthesizing CsPbBr₃ nanocrystals on the selected codes with additional treatment of CsBr (middle scheme of FIG. 7a). Correct information hidden in camouflaged SC information could be decrypted by removing fake signals through readout using PL under UV irradiation. For instance, when the programmed film was immersed in ethanol, SCs revealed a series of signals “-⋅⋅⋅(B)[ ]-⋅-⋅(C)[ ]⋅- -⋅(P),” indicating “BCP,” which is camouflage information. After removing the fake signals programmed in PL under UV, real signals “⋅⋅⋅(S)[ ]-⋅-⋅(C)” which corresponded to “(green, green, green) (S) (red) (blue, green, blue, green) (C)” were determined (the rightmost scheme of FIG. 7a). The SC and PL information programmed into our dual-mode BCP PC encryption display was erased with an NH₄OH solution, making the display ready for the next encryption of the information.

A rewritable dual-mode BCP PC encryption display was successfully developed; the results are shown in FIGS. 7b and 7c. As proposed in FIG. 7a, the alphabets of “BCP” were encoded in SC by controlling the doping time of PbBr₂, as shown in the left photograph in FIG. 7b. Through the subsequent synthesis of CsPbBr₃ nanocrystals on the selected regions, a patterned false PL image was obtained, as shown in the right photograph in FIG. 7b. Fake PL information was used to decipher the real information, as schematically shown in FIG. 7b. The correct “SC” information was determined by eliminating the fake PL information from the camouflage SC information of “BCP.” After resetting the pre-existing information by NH₄OH treatment, another camouflage SC information of the Morse code alphabets of “-⋅⋅-(P)[ ]-⋅(N)[ ]-⋅-⋅(C)” was written with PbBr₂ in the SC-coded alphabets of “(green, blue, blue, green) (P) (red) (blue, green) (N) (red) (blue, green, blue, green) (C),” as shown in the left photograph in FIG. 7c. Subsequently, three regions of the SC-coded pattern were treated with CsBr, giving rise to three PL-emitting fake information regions, as shown in the right photograph in FIG. 7c. The individual PL emission of the Morse-code-encoded encryption film shown in FIG. 7b was confirmed by measuring every circle of the codes (FIG. 7d). The PL intensities show emissions distinct from CsPbBr₃ synthesized circles, as shown in FIG. 7e. By eliminating the fake PL information from the camouflaged SC information (the schematics in FIG. 7c), the correct information of “PL” could be deciphered. Further, three colors of SC and PL for each of the information spots of 4×4 matrix of an encryption display could be encoded. In this situation, a total number of (3×3)¹⁶ (≈1.85×10¹⁵) cases should be considered to counterfeit one SC and PL dual-mode encryption display because the nine color combinations of SC and PL (3×3) are considered at the same time every pixel of the 4×4 matrix (16). The results based on our rewritable dual-mode SC and PL BCP PC encryption display offer a novel platform for high-security, cost-effective personalized encryption and anti-counterfeiting technologies.

### Experimental Example

According to an embodiment of the present disclosure, results of an actual experiment are introduced below.

### (1) Materials

Methylammonium bromide was purchased from Xi'an Co., China. N,N-DMF (anhydrous, 99.8%), methanol (MeOH, 99.5%), ethanol (EtOH, 99.9%), 1-propanol (PrOH, 99.9%), bromoethane, 1,4-dibromobutane, n-hexane, PGMEA, chloroform, ammonium hydroxide (28.0-0.0% aqueous), ammonium persulfate, hydrobromous acid (48 wt %), PbBr₂ (99.999%, trace metal standard) were purchased from Sigma-Aldrich.

### (2) Synthesis of PS-b-P2VP Block Copolymer

PS-b-P2VP was synthesized via sequential living anionic polymerization of styrene and 2-vinylpyridine in tetrahydrofuran at −78° C. under purified argon using sec-butyllithium as an initiator. The number-average molecular weight (Mₙ) was 90.8 kg·mol⁻¹ with a narrower dispersity (Ð=M_{w}/Mₙ) than 1.04, characterized by size-exclusion chromatography. The P2VP volume fraction (f_{P2VP}) of BCP was determined to be 0.32 by 1H nuclear magnetic resonance (¹H NMR), based on the mass densities of the two components (1.05 and 1.14 g cm⁻³ for PS and P2VP, respectively).

### (3) Preparation of BCP PC Films

BCP PC films were prepared by spin-coating PS-b-P2VP block copolymer solutions (7 wt % in PGMEA) onto silicon or glass substrates. The films were subsequently solvent-annealed in chloroform vapor at 50° C. for 24 hours. The P2VP layers were then selectively quaternized using 1-bromoethane and 1,4-dibromobutane in hexane at 60° C. for 24 hours.

### (4) Preparation of Topologically Micro-Patterned BCP PC Film

A thin Cu film was directly deposited on a BCP film via thermal evaporation with a micro-patterned metal mask. The reactive ion etching was subsequently performed on the BCP PC film with the patterned Cu film, which served as a pattern mask for reactive ion etching, in nitrogen and argon (5:1) atmosphere. The reactive ion etching was performed with CIONE4 Plasma Processing System with the power of 100 W, 50 kHz for 15 min. After the reactive ion etching process, the Cu mask was erased by immersing it in 5 wt % of ammonium persulfate solution for 1 second, followed by immediate washing with di-water, giving rise to a micro-patterned BCP PC film. Finally, the film was treated with 0.05 M of HBr water solution for 10 min to remove the residual ammonium persulfate in the micro-patterned BCP film.

### (5) Selective Printing of PbBr2 and Various Perovskite Nanocrystals in BCP PC Films

A PDMS mask film was fabricated with laser-cutting machine (NEJE 3 N30820). The PDMS mask film with the laser-cut holes was washed with ethanol and placed on the BCP PC film directly. For PbBr₂ doping into a BCP PC, PbBr₂/methanol solution with 1 wt % was dropped directly on the selective holes of the PDMS mask conformally placed on the BCP PC for 30 to 300 seconds. After doping of PbBr₂ in the BCP PC film, CsBr/methanol solution with 1 wt % was also dropped directly on the selective holes of PDMS mask for 1 min. CsPbBr₃ nanocrystals were synthesized immediately on the selectively deposited region. CsX/methanol solutions with 1 wt % were dropped to synthesize various CsPbX₃ perovskites. MAPbX₃ nanocrystals were synthesized by using 5 wt % of MAX/ethanol solutions instead of CsX/methanol solutions. 2D PEA₂MAₙ₋₁PbₙBr₃ₙ₊₁ nanocrystals were synthesized by using PEABr/MABr/ethanol solutions with 5 wt % instead of MABr/ethanol solutions. The ratio of PEABr and MABr was adjusted to (2:n−1) for synthesis of PEA₂MAₙ₋₁PbₙBr₃ₙ₊₁ nanocrystals with different layer thickness from n=1 to 3.

### (6) Preparation of Neat CsPbBr₃ Films

A bare CsPbBr₃ film was fabricated on a silicon and glass substrate by spin-coating and subsequent thermal annealing under inert conditions. The substrates were first cleaned in acetone and 2-propanol by sonication for 15 min each and treated with UV-O₃ for 15 min. CsBr and PbBr₂ precursor powders (200 mg mL⁻¹) in a 1:1 molar ratio were dissolved in DMSO at 70° C. with vigorous stirring. The predissolved CsPbBr₃ precursor solution was cooled to room temperature. The solution was then spin-coated on the substrate at 2000 rpm for 120 seconds in an N₂-filled glove box (less than 10 ppm H₂O and O₂). The as-cast film, which exhibited a transparent precursor state, was immediately transferred onto a hot plate for thermal annealing at 80° C. for 5 min to remove residual DMSO.

(7) PL Stability Test of CsPbBr₃ embedded BCP PC and neat CsPbBr₃ Films

Humidity test of films was conducted under an atmosphere with relative humidity of 70% at 20° C. for 72 hours. The thermal stability test of films was performed at 130° C. under an atmosphere with relative humidity of 20% for 24 hours. The 365 nm UV lamp with the power of 4 W from Sankyo Denki (Japan) was employed for UV irradiation test. The UV irradiation test was conducted under an atmosphere with relative humidity of 20% at 20° C. for 24 hours.

### (8) Characterization and Measurement

The cross-sectional morphologies of 1D in-plane lamellar structures of BCP PC films were imaged using an FIB to produce thin cross sections of dried films for bright-field transmission electron microscopy and EDS with a Cs-corrected STEM (spherical aberration-corrected scanning transmission electron microscope) (JEM-ARM 200F). The surfaces of the BCP PC films were observed using SEM (JEOL 7610F). Reflectance spectra were measured using a UV-vis-NIR spectrometer (V-650, JASCO). The FT-IR spectra of the films were recorded in attenuated total reflectance mode (Vertex 70, Bruker). The GISAXS and GIWAXS measurements were performed using the 9A beamline at the Pohang Acceleration Laboratory in Pohang, South Korea. GISAXS patterns were acquired at a sample-to-detector distance of 4490.997 mm, an incidence angle of 0.13°, and an intensity of 11.055 keV. GIWAXS measurements were performed at the same X-ray beam intensity and incidence angle as those used for the GISAXS measurements. In this case, the sample-to-detector distance was 240 mm. The thickness of the micro-patterned BCP PC films was measured using a DektakXT surface profiler (Bruker).

### (9) Numerical Simulation

The optical properties and the electrical field distributions of plasmonic structures were simulated by the COMSOL Multiphysics 6.1 (incorporated wave optics module). The refractive index n was =1.59, 1.61, and 2.55 for PS, P2VP, and CsPbBr₃ nanocrystals, respectively. To simplify the calculation, the nanocrystals were assumed to be uniformly dispersed in the P2VP lamellae, and the Si substrate was omitted in the model.

### (10) Ensemble Spectroscopic Measurement

The photoluminescence spectra of the films were recorded using a photoluminescence spectrometer (F-7100, Hitachi, Tokyo, Japan). The time-resolved photoluminescence of the films was evaluated using a time-correlated single-photon counting technique to measure spontaneous photoluminescence decay. The excitation light source was a mode-locked Ti:sapphire laser (MaiTai BB, Spectra-Physics, Santa Clara, CA, USA) that provided ultrashort pulses (80 fs full width at FWHM) with a high repetition rate (80 MHz). This high repetition rate could be reduced to 1-800 kHz using an in-house pulse picker. The pulse-picked output pulse was frequency-doubled using a 1-mm-thick BBO crystal (EKSMA, Vilnius, Lithuania). The PL of the films was measured using a microchannel plate photomultiplier (R3809U-51, Hamamatsu Photonics, Hamamatsu, Japan) with a thermoelectric cooler (C4878, Hamamatsu Photonics) connected to a time-correlated single photon counting board (SPC-130, Becker&Hickl GmbH, Berlin, Germany). The overall instrument response function was ˜25 ps (FWHM). A pump pulse, vertically polarized using a Glan laser polarizer, was used to irradiate the samples. A sheet polarizer set at an angle complementary to the magic angle (54.7°) was placed along the photoluminescence collection path to record the polarization-independent photoluminescence decay of the films.

The above description of the present disclosure is for illustrative purposes only, and those skilled in the art will appreciate that the present disclosure can be easily modified into other specific forms without changing the technical idea or essential characteristics of the present disclosure. Therefore, it should be understood that the embodiments described above are exemplary in all respects and not limiting.

The scope of the present disclosure is indicated by the appended claims, and all changes or modifications derived from the meaning and scope of the claims and their equivalent concepts should be construed as being included in the scope of the present disclosure.

What is claimed is:

1. A dual-responsive display comprising:
a block copolymer (BCP) photonic crystal (PC) film having a lamellar structure in which a first layer in which a first repeating unit is positioned and a second layer in which a second repeating unit coupled with the first repeating unit is positioned are alternately stacked, and exhibiting a structural color; and
nanocrystals exhibiting fluorescent photoluminescence dispersed in one of the first layer and the second layer,
wherein the structural color and the fluorescent photoluminescence are independently controlled.

2. The dual-responsive display of claim 1, wherein the block copolymer photonic crystal film comprises a poly(styrene-block-2-vinylpyridine) (PS-b-P2VP) copolymer, and
the first and second repeating units each comprise a PS repeating unit and a P2VP repeating unit.

3. The dual-responsive display of claim 2, wherein the P2VP repeating units are cross-linked to each other.

4. The dual-responsive display of claim 2, further comprising a first precursor compound of the nanocrystal coordinately bonded to the P2VP repeating unit.

5. The dual-responsive display of claim 4, wherein the nanocrystals are formed by a reaction between the first precursor compound and a second precursor compound, and dispersed in a layer among the first and second layers in which the P2VP repeating unit is positioned.

6. The dual-responsive display of claim 5, wherein the first precursor compound comprises PbX₂, and
the second precursor comprises at least one of CsX and MAX,
wherein X is I, Br, or Cl.

7. The dual-responsive display of claim 1, wherein the nanocrystals are perovskite nanocrystals.

8. The dual-responsive display of claim 7, wherein the perovskite nanocrystals comprise 3D CsPbX₃ or 3D MAPbX₃, wherein MA is methyl ammonium and X is I, Br, or Cl.

9. The dual-responsive display of claim 7, wherein the perovskite nanocrystals comprise 2D PEA₂MAₙ₋₁PbₙBr₃ₙ₊₁, wherein MA is methyl ammonium, PEA is phenylethyl ammonium, and n is 1, 2, or 3.

10. A dual-responsive photoencryption display comprising:
a block copolymer (BCP) photonic crystal (PC) film having a lamellar structure in which a first layer in which a first repeating unit is positioned and a second layer in which a second repeating unit coupled with the first repeating unit is positioned are alternately stacked;
a first precursor compound bonded to one of the first and second repeating units in a plurality of different regions of the block copolymer (BCP) photonic crystal (PC) film; and
nanocrystals exhibiting fluorescent photoluminescence, which are dispersed in a part of the plurality of different regions and positioned in one of the first layer and the second layer.

11. The dual-responsive photoencryption display of claim 10, wherein a concentration of the first precursor compound doped into a first region among the plurality of different regions is different from a concentration of the first precursor compound doped into a second region, such that a structural color generated from the first region is different from a structural color generated from the second region.

12. The dual-responsive photoencryption display of claim 11, wherein the concentration of the first precursor compound in the first region is greater than 0 to 3 wt %, and
the concentration of the first precursor compound in the second region is from 0 wt % to 0.1 wt %.

13. The dual-responsive photoencryption display of claim 10, wherein the first precursor compound comprises PbX₂,
wherein X is I, Br, or Cl.

14. The dual-responsive photoencryption display of claim 10, wherein the nanocrystals are perovskite nanocrystals.

15. The dual-responsive photoencryption display of claim 14, wherein the perovskite nanocrystals comprise 3D CsPbX₃ or 3D MAPbX₃, wherein MA is methyl ammonium and X is I, Br, or Cl.

16. The dual-responsive photoencryption display of claim 14, wherein the perovskite nanocrystals comprise 2D PEA₂MAₙ₋₁PbₙBr₃ₙ₊₁, wherein MA is methyl ammonium, PEA is phenylethyl ammonium, and n is 1, 2, or 3.

17. A method of manufacturing a dual-responsive display, the method comprising:
a first step of forming a block copolymer (BCP) photonic crystal (PC) film on a substrate;
a second step of doping a first precursor compound into the formed block copolymer photonic crystal film; and
a third step of forming nanocrystals within the block copolymer photonic crystal film by introducing a second precursor compound which reacts with the first precursor compound into a region doped with the first precursor compound,
wherein the block copolymer (BCP) photonic crystal (PC) film has a lamellar structure in which a first layer in which a first repeating unit is disposed and a second layer in which a second repeating unit coupled with the first repeating unit is disposed are alternately stacked.

18. The method of claim 17, wherein the first precursor comprises PbX₂, and the second precursor comprises at least one of CsX and MAX,
wherein X is I, Br, or Cl.

19. The method of claim 17, wherein the first and second repeating units in the block copolymer photonic crystal film each comprise a PS repeating unit and a P2VP repeating unit.

20. The method of claim 19, wherein the first step comprises: (a) coating a solution comprising a poly(styrene-block-2-vinylpyridine) (PS-b-P2VP) copolymer comprising the first and second repeating units onto the substrate; and (b) annealing a solvent and then quaternizing the first layer comprising the P2VP repeating unit using an organic compound.

21. The method of claim 17, further comprising, between the first step and the second step, forming a mark layer on one surface of the formed block copolymer photonic crystal film to define a plurality of different regions.
